(19) United States
(12) Patent Application Publication
(10) Pub. No.: US 2015/0294453 A1
(43) Pub. Date: Oct. 15, 2015

(54) IMAGE ANALYSIS APPARATUS MOUNTED TO VEHICLE

(71) Applicant: DENSO CORPORATION, Kariya-city, Aichi-pref. (JP)

(72) Inventor: Hiroki NAKANO, Okazaki-shi, Aichi-ken (JP)

(21) Appl. No.: 14/411,113

(22) PCT Filed: Jun. 28, 2013
(86) PCT No.: PCT/JP2013/067818

§ 371 Date: Dec. 24, 2014

(30) Foreign Application Priority Data
Jun. 29, 2012 (JP) 2012-147005

(51) Int. Cl. G06T 7/00; H04N 5/232

(52) U.S. Cl. CPC G06T 7/004; H04N 5/23222; G06T 2207/10004; G06T 2207/30252

(57) ABSTRACT

An image of a region in front of a vehicle is picked up by a camera and analyzed by a control unit to learn a focus-of-expansion position. The control unit controls learning of a focus-of-expansion position based on outputs of a wheel-speed sensor and an acceleration sensor. Specifically, the control unit keeps the learning process in an off-state until a vehicle speed specified from an output of the wheel-speed sensor exceeds a reference speed. When the vehicle speed exceeds the reference speed, the control unit determines whether an error is less than a threshold, the error being between a vehicle speed calculated from an integrated value of an acceleration on the basis of an output of the acceleration sensor up to then, and a vehicle speed specified from an output of the wheel-speed sensor, and then starts learning the focus-of-expansion position if the error is less than the threshold.

### CROSS REFERENCE TO RELATED APPLICATIONS

This application is a U.S. National Phase Application under 35 U.S.C. 371 of International Application No. PCT/JP2013/067818 filed on Jun. 28, 2013 and published in Japanese as WO 2014/003168 A1 on Jan. 3, 2014. This application is based on and claims the benefit of priority from Japanese Patent Application No. 2012-147005 filed Jun. 29, 2012. The entire disclosures of all of the above applications are incorporated herein by reference.

### BACKGROUND

1. Technical Field

The present invention relates to an image analysis apparatus mounted to a vehicle, and in particular to an image analysis apparatus mounted to a vehicle, which performs image analysis based on the position of a focus of expansion.

2. Background Art

Recently, there is provided a system for obtaining various pieces of information regarding running of a vehicle. In such a system, a camera is installed in the vehicle and image data picked up by the camera are used for obtaining the various pieces of information. An example of such a system is disclosed in Patent Literature 1. The system related to Patent Literature 1 is an in-vehicle type system that analyzes picked-up image data obtained from an in-vehicle camera to calculate the position of a focus of expansion (FOE) to thereby estimate a posture of the in-vehicle camera. The focus of expansion refers to a point where a group of parallel lines are concentrated in a perspective drawing method.

According to an in-vehicle system of this type, picked-up image data are analyzed taking account of the posture of the in-vehicle camera. Thus, for example, the system enables calculation of a running state of the vehicle in relation to the road, or a distance to a vehicle running in a forward direction.

Patent Literature 1 JP-A-H07-077431

### Technical Problem

For example, in learning a focus-of-expansion position, steep edges in luminance variation are extracted from picked-up image data to estimate a region defined by road division lines (e.g., white lines, Botts' dots, etc.) shown in the picked-up image data. Then, the edges corresponding to the road division lines are linearly approximated to obtain two straight lines, followed by calculating an intersection position of the two straight lines. For example, candidates of the focus of expansion are calculated on the basis of a weighted time average of the intersection position.

For example, probability evaluation is performed for the candidates of the focus of expansion by comparing the candidates with a focus-of-expansion position learned in the past to thereby reject those candidates which have low probability. Then, the candidate that has not been rejected is used as a focus of expansion to thereby learn a focus-of-expansion position. For example, the information of the learned focus-of-expansion position is used in estimating edges that are most probable as road division lines.

A focus-of-expansion position is learned while the vehicle runs. As shown in FIG. 8, in a vehicle inspection, a vehicle 100 is often placed on a chassis dynamometer 200 to perform a simulated run. In such a vehicle inspection, a focus-of-expansion position may be learned in spite of the fact that the vehicle 100 does not run on a road, and thus error learning of a focus-of-expansion position may occur. For example, when there is a wall 210 ahead of a camera 11, stains on the wall 210, or the shadows cast from nearby constructions onto the wall 210 may be erroneously estimated as road division lines, causing error learning of a focus-of-expansion position.

### SUMMARY

In light of such a problem, it is desired to suppress the occurrence of error learning of a focus-of-expansion position in performing a simulated run of a vehicle.

According to a typical example, there is provided an image analysis apparatus mounted to a vehicle. The image analysis apparatus includes a camera, a learning means and a controlling means. The camera picks up an image of a region in a forward direction of the vehicle and generates image data that show the picked-up image. The learning means analyzes the image data generated by the camera and learns a focus-of-expansion position. On the other hand, the controlling means controls on/off of a learning performance for a focus-of-expansion position performed by the learning means, on the basis of an output of an inertia sensor provided to the vehicle.

The learning means is configured, for example, to learn a focus-of-expansion position on the basis of an estimation result of road division lines shown in the image data. On the other hand, the controlling means may be configured to determine whether or not the vehicle is in a state of running on a road on the basis of an output of the inertia sensor, and on condition that the vehicle is determined to be in a state of running on a road, to switch the learning performance from an off-state to an on-state.

When the vehicle is in a simulated run on a chassis dynamometer such as in a vehicle inspection, a vehicle speed that is not zero is detected by a wheel-speed sensor. Therefore, according to the conventional art, there is a probability that the vehicle is determined to be running on a road on the basis of the output of the wheel-speed sensor to thereby allow the learning performance for a focus-of-expansion position to be performed. On the other hand, when the vehicle is in a simulated run, the physical quantities, such as an acceleration or an angular velocity, detected by the inertia sensor are substantially zero, unlike those detected by the wheel-seed sensor. Accordingly, when the output of the inertia sensor is used as a basis, whether or not the vehicle is in a simulated run on a chassis dynamometer can be determined.

Accordingly, when on/off of the learning performance for a focus-of-expansion position performed by the learning means is controlled on the basis of the output of the inertia sensor, on/off control can be performed for the learning performance in such a way that the learning of a focus-of-expansion position is not performed in a state where the vehicle is in a simulated run on a chassis dynamometer. As a result, error learning of a focus-of-expansion position is suppressed from occurring, which would otherwise have been caused due to the learning of a focus-of-expansion position during a simulated run of the vehicle.

An acceleration sensor may be used as the inertia sensor. The controlling means may be configured, for example, to switch the learning performance from an off-state to an on-state on condition that a speed of the vehicle calculated by integrating acceleration of the vehicle, which is specified from an output of the acceleration sensor, has exceeded a reference speed.

Other than the above, the controlling means may be configured to control switching on/off of the learning performance for a focus-of-expansion position performed by the learning means, on the basis of an output of the wheel-speed sensor provided to the vehicle.

For example, the controlling means may be configured to switch the learning performance from an off-state to an on-state on the basis of an error on condition that the error is less than a reference. In this case, the error is between an acceleration of the vehicle calculated from a deviation in a speed of the vehicle specified from the output of the wheel-speed sensor and an acceleration of the vehicle specified from an output of the acceleration sensor, or between a speed of the vehicle specified from an output of the wheel-speed sensor and a speed of the vehicle calculated by integrating acceleration of the vehicle, which is specified from an output of the acceleration sensor.

In a state where the vehicle is in a simulated run, there is a probability that a value that is not zero is detected by the inertia sensor. On the other hand, when the error mentioned above is concerned, the error is prominently shown in a state where the vehicle is in a simulated run. Accordingly, when the learning performance is on/off-controlled, using the error as an index, highly accurate on/off control of the learning performance can be realized, while suppressing the occurrence of error learning.

According to another preferred example, the controlling means may be configured to switch the learning performance from an off-state to an on-state on condition that a speed of the vehicle specified from an output of the wheel-speed sensor exceeds a reference speed and the error is less than a reference. When the learning performance for a focus-of-expansion position is performed on a road of poor visibility, such as a narrow street, error learning is likely to occur. Accordingly, in a situation in which the vehicle runs at a low speed that indicates a high probability of running on a bad road with poor visibility, the learning performance is ensured to be retained to be in an off-state. Also, the learning performance is ensured to be switched to an on-state on condition that the speed of the vehicle has exceeded a reference speed. When the learning performance is on/off-controlled in this way, the learning performance for a focus-of-expansion position is more properly performed.

Besides, the controlling means may be configured to switch the learning performance from an off-state to an on-state on condition that a speed of the vehicle specified from an output of the wheel-speed sensor has exceeded a reference speed, and an acceleration of the vehicle specified from an output of the acceleration sensor has exceeded a reference acceleration. According to this control method as well, the learning performance for a focus-of-expansion position can be properly conducted.

### BRIEF DESCRIPTION OF THE DRAWINGS

In the accompanying drawings:

FIG. 1 is a block diagram illustrating a configuration of a first embodiment of a vehicle control system which is equipped with an image analysis apparatus related to the present invention;

FIG. 2 is a block diagram illustrating a correlation of a plurality of processes performed by a control unit of the vehicle control system;

FIG. 3 is a flow chart illustrating a learning control process of the first embodiment performed by the control unit;

FIG. 4 is a flow chart illustrating a learning control process of a second embodiment of the vehicle control system which is equipped with the image analysis apparatus related to the present invention;

FIG. 5 is a flow chart illustrating an error statistic calculation process in the second embodiment;

FIG. 6 is a flow chart illustrating a learning control process of a third embodiment of the vehicle control system which is equipped with the image analysis apparatus related to the present invention;

FIG. 7 is a flow chart illustrating a learning control process of a fourth embodiment of the vehicle control system which is equipped with the image analysis apparatus related to the present invention; and

FIG. 8 is a diagram illustrating a state of a vehicle in a simulated run on a chassis dynamometer.

### DESCRIPTION OF EMBODIMENTS

With reference to the accompanying drawings, hereinafter are described some embodiments of an image analysis apparatus related to the present invention.

### First Embodiment

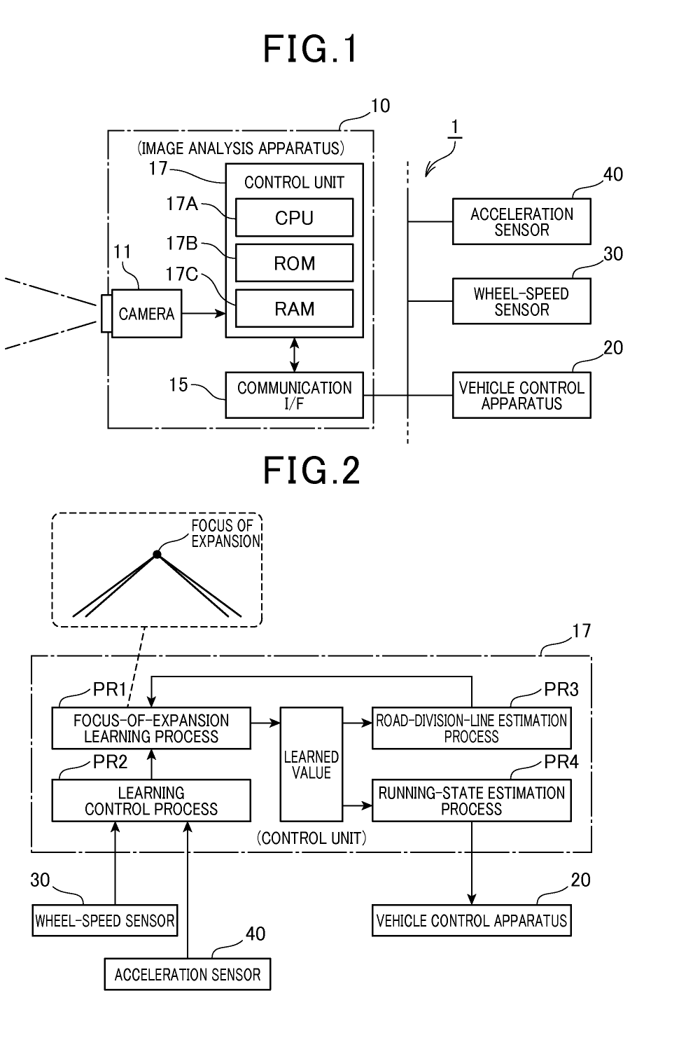

The image analysis apparatus related to the present invention is implemented being incorporated in a vehicle control system which is mounted to a vehicle. FIG. 1 illustrates a configuration of this vehicle control system 1. As shown in the figure, the vehicle control system 1 includes an image analysis apparatus 10 as an in-vehicle type electronic machine, a vehicle control apparatus 20, a wheel-speed sensor 30 and an acceleration sensor 40. In the vehicle control system 1, the image analysis apparatus 10, the vehicle control apparatus 20, the wheel-speed sensor 30 and the acceleration sensor 40 are individually connected to an in-vehicle network and configured to enable mutual communication.

The in-vehicle network is connected not only with the wheel-speed sensor 30 and the acceleration sensor 40, but also with various sensors (not shown) capable of detecting running/operating conditions of the vehicle, such that the sensors can provide the detection values. As is known, the wheel-speed sensor 30 outputs a vehicle speed signal according to the rotation of the wheel. Thus, by detecting the rotating speed of the wheel, the speed of the vehicle is indirectly detected. On the other hand, the acceleration sensor 40 is an inertia sensor that performs measurements making use of inertia. As is known, the acceleration sensor 40 detects and outputs an acceleration of the vehicle on the basis of the displacement of a member due to inertia.

The image analysis apparatus 10 includes a camera 11, a communication interface 15 and a control unit 17. The camera 11 picks up an image of a field of view in a forward direction of the vehicle that is equipped with the vehicle control system 1 (so-called own vehicle) to generate picked-up image data as image data that show the picked-up image and sequentially input the picked-up image data to the control unit 17. In the present embodiment, a monocular camera is used as the camera 11, but a stereo camera may be used instead.

The communication interface 15 is controlled by the control unit 17 and configured to enable two-way communication with communication nodes, such as the vehicle control apparatus 20, the wheel-speed sensor 30 and the acceleration sensor 40, via the in-vehicle network.

The control unit 17 carries out overall control of the image analysis apparatus 10. The control unit 17 includes a CPU 17A, a ROM 17B and a RAM 17C. In the control unit 17, the CPU 17A executes various processes according to programs stored in the ROM 17B to thereby realize various functions as the image analysis apparatus 10. The RAM 17C is used as a working memory when the programs are executed by the CPU 17A.

The control unit 17 performs a focus-of-expansion learning process PR1, a learning control process PR2, a road-division-line estimation process PR3, a running-state estimation process PR4, and the like shown in FIG. 2, according to the programs stored in the ROM 17B. The focus-of-expansion learning process PR1 is a process for learning a focus-of-expansion (FOE) position in picked-up image data according to a well-known technique. A learned focus-of-expansion position is stored in the ROM 17B as a parameter indicating a camera posture. For example, the ROM 17B of the present embodiment includes an electrically data rewritable flash memory.

Further, the learning control process PR2 is a process for controlling the execution of the focus-of-expansion learning process PR1. The control unit 17 executes the learning control process PR2 to control the start (on)/termination (off) of the focus-of-expansion learning process PR1.

Besides, the road-division-line estimation process PR3 is a process for estimating a region defined by road division lines that are shown in picked-up image data. In the road-division-line estimation process PR3, edges, as candidates of road division lines, are extracted from picked-up image data. Then, based on a positional relationship of the directions of these edges with the learned focus of expansion, edges having a probability of being the road division lines of the road on which the own vehicle runs are determined. Thus, the region defined by the road division lines of the road on which the own vehicle runs is estimated. If a focus of expansion has not been learned, a focus-of-expansion position calculated from installation parameters of the camera 11, for example, is used as an index to estimate road division lines.

In the focus-of-expansion learning process PR1, a focus-of-expansion position can be learned on the basis of the road division lines estimated through the road-division-line estimation process PR3. For example, an intersection that appears on an extension of two estimated road division lines is detected as a candidate of a focus of expansion. Then, an error between the position of the detected candidate and the learned focus-of-expansion position is used for the evaluation as to the probability of the candidate's being a focus of expansion. If the error is large and thus the probability is low, the candidate is rejected. If the error is small and thus the probability is high, the candidate is used as a focus of expansion to thereby learn and update the focus-of-expansion position stored in the ROM 17B.

Besides, the running-state estimation process PR4 is a process for analyzing picked-up image data using the learned focus-of-expansion position as an index to estimate a running state of the own vehicle in relation to the road, or a positional relationship with a vehicle running in a forward direction. Since the running-state estimation process PR4 is well known, the process is only briefly described. As an example of the running-state estimation process PR4, there is a process for estimating the direction or position of the own vehicle relative to the running lane, on the basis of the road division lines (e.g., white lines or Bott's dots) estimated from picked-up image data. Other than this, as an example of the running-state estimation process PR4, there is a process for retrieving and detecting, with reference to a focus-of-expansion position, a vehicle running in a forward direction and shown in picked-up image data, or estimating a positional relationship between a vehicle detected in a forward direction and the own vehicle (e.g., distance from the own vehicle to a vehicle in a forward direction).

Information resulting from the estimation in the running-state estimation process PR4 is provided, for use in vehicle control, to the vehicle control apparatus 20 via the communication interface 15 and the in-vehicle network. The information includes a running state of the own vehicle in relation to the road, and a positional relationship with a vehicle running in a forward direction. The term “vehicle control” here is used in a broad sense as a control over the devices in the vehicle. The vehicle control apparatus 20 can perform the vehicle control based on the information obtained from the image analysis apparatus 10, the vehicle control including, for example: a process of outputting an audible warning to the vehicle occupants when the own vehicle crosses road division lines during the run, or when the own vehicle approaches a vehicle in a forward direction; or a process of controlling braking to keep a proper inter-vehicle distance to a vehicle in a forward direction.

Since a learned value of a focus-of-expansion position is used in estimating road division lines or estimating a running state, occurrence of error learning of a focus-of-expansion position is not favorable. However, when the learning of a focus-of-expansion position is carried out under the conditions where the vehicle 100 is in a simulated run, being placed on the chassis dynamometer 200 in a vehicle inspection, the camera 11 may pick up an image such as of the stains on the wall 210 ahead of the own vehicle or the shadows cast from nearby constructions onto the wall 210. These stains and shadows may induce error learning of a focus-of-expansion position.

Depending on such error learning, a position which is greatly deviated from a truly correct focus-of-expansion position may be learned as a focus-of-expansion position. In the occurrence of such a deviation, the learned value may no longer be restored to a correct focus-of-expansion position through the learning process performed afterward, or otherwise a long time may be taken for the restoration.

The road-division-line estimation process PR3 uses a learned value of a focus-of-expansion position. In this case, for example, if the focus-of-expansion position obtained through error learning is used as a basis, it may be difficult to determine correct edges that serve as road division lines. If a correct focus of expansion can be detected as a candidate of a focus of expansion in the focus-of-expansion learning process PR1, there is a probability that the candidate is not used for learning due to the deviation of the position of the candidate from a learned focus-of-expansion position.

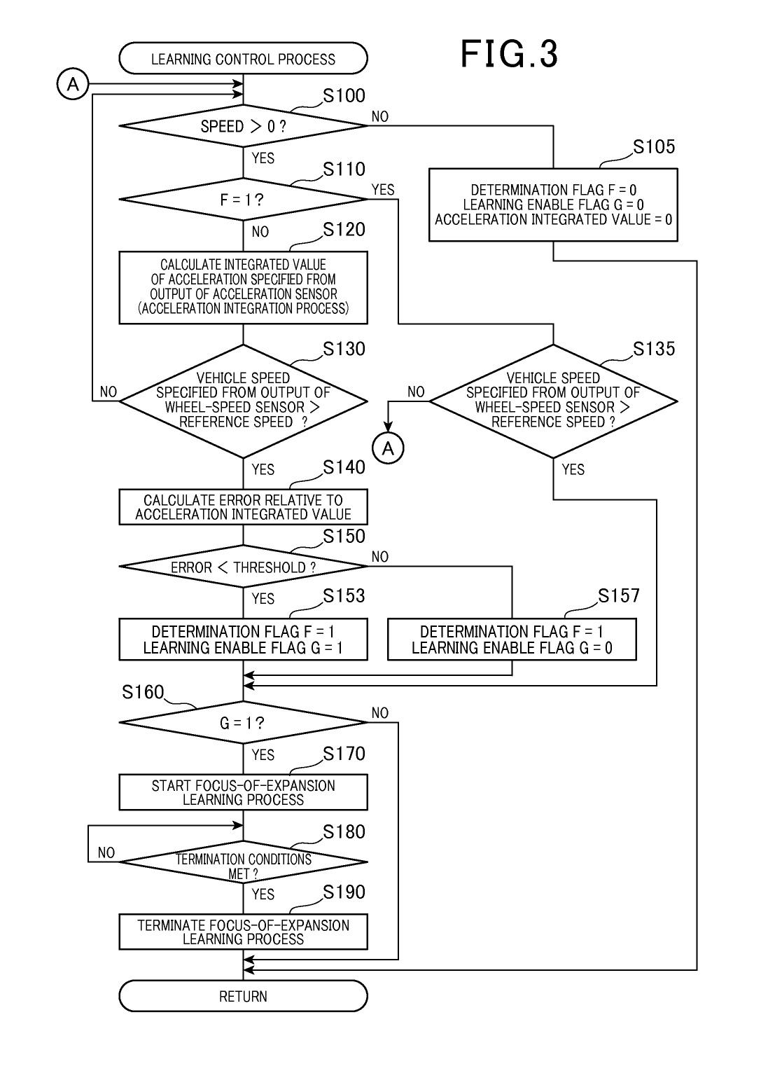

In this regard, in the present embodiment, a process as shown in FIG. 3 is performed as the learning control process PR2. Thus, under the conditions where the vehicle 100 has a high probability of being in a simulated run, being placed on the chassis dynamometer 200, the focus-of-expansion learning process PR1 is not started but the learning performance is retained to be in an off-state.

The control unit 17 starts the learning control process PR2 shown in FIG. 3 when the ignition switch is turned on, and repeatedly performs the process at a predetermined cycle until the ignition switch is turned off.

Upon start of the learning control process PR2, the control unit 17 determines whether or not a vehicle speed specified from an output of the wheel-speed sensor 30, which has been obtained via the in-vehicle network and the communication interface 15, is larger than zero (step S100). Then, if the vehicle speed is determined to be not more than zero, control transfers to step S105. If the vehicle speed is determined to be higher than zero, control transfers to step S110.

After transfer to step S105, the control unit 17 resets a determination flag F and a learning enable flag G to a value zero. At the same time, the control unit 17 resets an acceleration integrated value to a value zero, followed by temporarily halting the learning control process PR2. The determination flag F here refers to a flag that indicates whether or not a determination has been made as to whether or not the vehicle runs on a road (in other words, whether or not the vehicle is in a simulated run). The value 0 indicates that a determination has not yet been made, while the value 1 indicates that a determination has been made. Further, the learning enable flag is a flag that indicates whether or not performing the focus-of-expansion learning process PR1 has been allowed. The value 0 indicates no allowance (inhibition), while the value 1 indicates allowance. In addition, the acceleration integrated value is calculated in an acceleration integration process (step S120) discussed later.

After transfer to step S110, the control unit 17 determines whether or not the determination flag F is set to the value 1. If the determination flag F is determined to have been set to the value 1 (Yes at step S110), control transfers to step S135. If the determination flag F is determined not to have been set to the value 1 (No at step S110), control transfers to step S120. The determination flag F is reset to a value zero when the ignition switch is turned on. Accordingly, at the initial step S110, a negative determination is made (No at step S110) and then control transfers to step S120.

After transfer to step S120, the control unit 17 carries out a process of calculating an integrated value of acceleration since a time point when the last acceleration integrated value has been reset to a value zero at step S105 (acceleration integration process). This process is based on the acceleration of the vehicle which is specified from the output of the acceleration sensor 40 obtained via the in-vehicle network and the communication interface 15. Thus, the output of the acceleration sensor 40 is used for estimating the actual speed of the vehicle from when the vehicle has started to run. At step S120, for example, the control unit 17 performs a process of multiplying the executed cycle of step S120 with the acceleration of the vehicle specified this time to obtain a speed change, and adding the obtained speed change to the acceleration integrated value previously calculated at step S120. Thus, the control unit 17 calculates an integrated value of acceleration (speed of the vehicle) from when the vehicle speed has turned to a value larger than zero.

Further, after finishing the processing at step S120, the control unit 17 transfers to step S130. At step S130, the control unit 17 compares the vehicle speed specified from the output of the wheel-speed sensor 30 with a reference speed determined in advance at a design stage, and determines whether or not the vehicle speed exceeds the reference speed. It should be noted that the reference speed may be determined by a designer from a viewpoint that whether or not the learning of a focus-of-expansion position can be properly performed. Since learning of a focus-of-expansion position can be properly performed on a road with good visibility, the reference speed may be set, for example, to about 50 km per hour.

If the vehicle speed specified from the output of the wheel-speed sensor 30 is determined not to have exceeded the reference speed (No at step S130), the control unit 17 transfers to step S100. At step S100, the control unit 17 repeatedly performs the processing of steps S100 to S130 until the vehicle speed exceeds the reference speed. On the other hand, if the vehicle speed specified from the output of the wheel-speed sensor 30 is determined to have exceeded the reference speed (Yes at step S130), the control unit 17 calculates a vehicle speed specified from the output of the wheel-speed sensor 30 at the moment, and calculates an error (absolute value) relative to the acceleration integrated value (step S140).

Then, it is determined whether or not the error is less than a threshold that has been determined in advance at a design stage (step s150). If the error is determined to be less than the threshold (Yes at step S150), the determination flag F is set to the value 1, and the learning enable flag G is set to the value 1 (step S153), followed by transferring to step S160. In contrast, if the error is determined to be not less than the threshold (No at step S150), the control unit 17 sets the determination flag F to the value 1, while retaining a state where the learning enable flag G is reset to the value 0 (step S157), followed by transferring to step S160.

The threshold used at step S150 may be obtained and determined by conducting experiments or the like. The threshold is ensured to be a value that can draw out a negative determination with a high probability at step S150 when the vehicle 100 is in a state of a simulated run on the chassis dynamometer 200, and draw out an affirmative determination with a high probability when the vehicle is not in a state of a simulated run but in a state of running on a road.

In other words, at step S150, it is determined whether or not the error is less than the threshold to thereby determine whether or not the vehicle 100 runs on a road. As far as the error is less than the threshold, the learning enable flag G is set to the value 1 to thereby allow the execution of the focus-of-expansion learning process PR1. If the error is not less than the threshold, the vehicle 100 is determined to have a high probability of being in a simulated run on the chassis dynamometer 200, thereby inhibiting the focus-of-expansion learning process PR1 from being executed.

Then, at step S160, it is determined whether or not the learning enable flag G is set to the value 1. If the learning enable flag G is determined to be set to the value 1 (Yes at step S160), the focus-of-expansion learning process PR1 is started (step S170), followed by transferring to step S180. At step S180, if the learning enable flag G is determined not to have been set to the value 1 (No at step S160), the learning control process is temporarily halted without starting the focus-of-expansion learning process PR1.

After transfer to step S180, the control unit 17 determines whether or not termination conditions of the focus-of-expansion learning process PR1 have been met. At this step, it is determined whether or not the vehicle speed specified from the output of the wheel-speed sensor 30 has turned to not more than a learning termination speed which is not more than the reference speed and falls within a predetermined speed range (e.g., 50 km per hour). If the vehicle speed is not more than the learning termination speed, the termination conditions are determined to have been met. If the vehicle speed is higher than the learning termination speed, the termination conditions are determined not to have been met. However, the termination conditions may be optionally determined by a designer of the image analysis apparatus 10.

Then, if the termination conditions are determined not to have been met (No at step S180), the control unit 17 repeatedly makes a determination at step S180 until the termination conditions are met. If the termination conditions are determined to have been met (Yes at step S180), the focus-of-expansion learning process PR1 is terminated (step S180), followed by temporarily halting the learning control process PR2.

Further, in a learning control process which is performed again after performing the processing of step S150 onward and temporarily halting the learning control process, the control unit 17 makes use of the determination result of step S150 of the previous cycle to control on/off of the learning performance. This on/off control is performed on the premise that the state of the vehicle, whether the vehicle may be running on a road or in a simulated run, remains unchanged until the vehicle speed specified from the output of the wheel-speed sensor 30 temporarily drops down to zero.

In other words, the determination flag F that is set to the value 1 at steps S153 and 157 is retained to the value 1 until the vehicle speed specified from the output of the wheel-seed sensor 30 temporarily drops down to zero and the processing at step S105 is performed. Accordingly, in the learning control process before the vehicle speed temporarily drops down to zero, an affirmative determination is made at step S110 and then control transfers to step S135.

At step S135, similar to the processing at step S130, it is determined whether or not the vehicle speed specified from the output of the wheel-speed sensor 30 has exceeded the reference speed. Then, if the vehicle speed is determined not to have exceeded the reference speed (No at S135), control transfers to step S100. If the vehicle speed is determined to have exceeded the reference speed (Yes at S135), control transfers to step S160. Then, in the processings at step S160 onward (steps S160 to S190), as far as an affirmative determination is made at step S150 in the learning control process of the past and accordingly the learning enable flag G is set to the value 1 (Yes at step S160), the focus-of-expansion learning process PR1 is started (step S170).

The vehicle control system 1 of the present embodiment has so far been described. According to the present embodiment, the camera 11 picks up an image of a region in a forward direction of the own vehicle, and picked-up image data generated by the camera 11 are analyzed by the control unit 17 to thereby learn a focus-of-expansion position. On the other hand, switching on/off of the learning performance for the focus-of-expansion position is controlled on the basis of the output of the acceleration sensor 40 that is an inertia sensor.

When the vehicle 100 is in a simulated run on the dynamometer 200 such as in a vehicle inspection, the wheel-speed sensor 30 detects a vehicle speed that is not zero. Therefore, according to the conventional art, the vehicle is determined to be running on a road on the basis of the output of the wheel-speed sensor 30, leading to a probability of performing error learning of a focus of expansion. In contrast, according to the present embodiment, a determination as to whether or not the vehicle is running on a road is made on the basis of the output of the acceleration sensor 40 that measures an acceleration making use of inertia (step S150), and far as the vehicle is determined to be running on a road, the learning performance is turned on (step S170).

Accordingly, when on/off of the learning performance for a focus of expansion is controlled as in the present embodiment, the learning of a focus of expansion can be suppressed from being performed in a state where the vehicle 100 is in a simulated run on the chassis dynamometer 200. Thus, according to the present embodiment, the learning of a focus of expansion is suppressed from occurring in a simulated run of the vehicle. As a result, unfavorable influence is suppressed from being given, due to the error learning, to the vehicle control and the learning of a focus of expansion that follows.

For example, depending on the focus-of-expansion learning process PR1, the focus-of-expansion position is learned and updated on the basis of the information on the road division lines shown in the picked-up image data that have been estimated in the road-division-line estimation process PR3, and the information of the learned focus of expansion is used for the estimation of road division lines. Therefore, if the learned focus-of-expansion position is deviated to a large extent from a correct position due to error learning of a focus-of-expansion position, road division lines can no longer be accurately estimated. As a result, there is a probability that a long time is taken for learning and updating the focus-of-expansion position to a correct value, or that an adverse situation is created for learning and updating the focus-of-expansion position to a correct value.

According to the present embodiment, the occurrence of such a situation can be suppressed by the control of the learning performance described above. This leads to the formulation of the vehicle control system 1 which realizes proper vehicle control on the basis of the information of a focus of expansion.

Furthermore, according to the present embodiment, an error is obtained, the error being between a speed of the vehicle specified from the output of the wheel-speed sensor 30 and a speed of the vehicle calculated by integrating the acceleration specified from the output of the acceleration sensor 40. On the basis of the error, the learning performance is switched from an off-state to an on-state as long as the error is less than a reference (Yes at step S150). Accordingly, a determination and on/off control of higher accuracy can be realized compared to the case where the output of the acceleration sensor 40 alone is used as a basis of determining whether or not the vehicle is in a state of running on a road, followed by on/off-controlling the learning performance. Thus, the occurrence of error learning of a focus-of-expansion position can be further suppressed.

Besides, when the learning performance for a focus-of-expansion position is performed on a road of poor visibility, such as a narrow street, error learning is likely to occur. According to the present embodiment, in a low-speed running in which the vehicle has a high probability of running on a bad road having poor visibility, the learning performance is ensured to be retained to be an off-state.

In other words, until when the vehicle speed specified from the output of the wheel-speed sensor 30 exceeds a reference speed (No at step S130), the learning performance is retained to be an off-state. Further, when the vehicle speed exceeds the reference speed (Yes at step S130), the learning performance is switched to an on-state. With this configuration, it is ensured that the learning performance is switched from an off-state to an on-state under the condition that the vehicle speed specified from the output of the wheel-speed sensor 30 exceeds the reference speed and the above-mentioned error is less than a reference. In this way, according to the present embodiment, error learning of a focus-of-expansion position can be further suppressed from occurring.

### Second Embodiment

Subsequently, a second embodiment is described.

In the second embodiment and the subsequent embodiments, the components and processes of the system, which are identical with or similar to those described in the first embodiment, are given the same reference numerals for the sake of omitting or simplifying explanation.

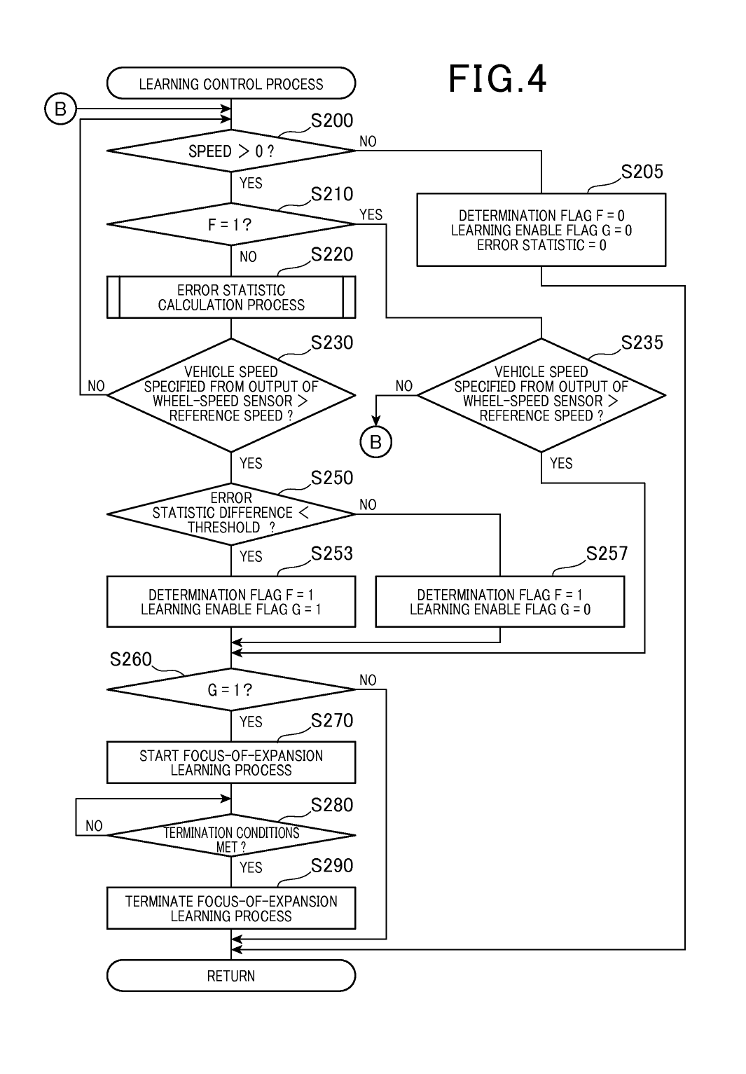

The vehicle control system 1 of the second embodiment is different to some extent from the first embodiment in the learning control process PR2 performed by the control unit 17. Accordingly, the learning control process PR2 of the second embodiment is selectively described below. The control unit 17 of the present embodiment starts the learning control process PR2 shown in FIG. 4 when the ignition switch is turned on and repeatedly performs the process at a predetermined cycle until the ignition switch is turned off.

Upon start of the learning control process PR2, the control unit 17 determines, similar to the first embodiment, whether or not the vehicle speed specified from the output of the wheel-speed sensor 30 is larger than zero (step S200). If the vehicle speed is determined to be not more than zero, control transfers to step S205. If the vehicle speed is determined to be higher than zero, control transfers to step S210.

After transfer to step S205, the control unit 17 resets, similar to the processing at step S105, the determination flag F and the learning enable flag G to a value zero. At the same time, the control unit 17 resets an error statistic to a value zero, followed by temporarily halting the learning control process PR2. The error statistic is calculated in an error statistic calculation process (step S220) discussed later.

On the other hand, after transfer to step S210, the control unit 17 determines whether or not the determination flag F is set to the value 1. If the determination flag F is determined to be set to the value 1 (Yes at step S210), control transfers to step S235. If it is determined that the determination flag F is not set to the value 1 (No at step S210), control transfers to step S220.

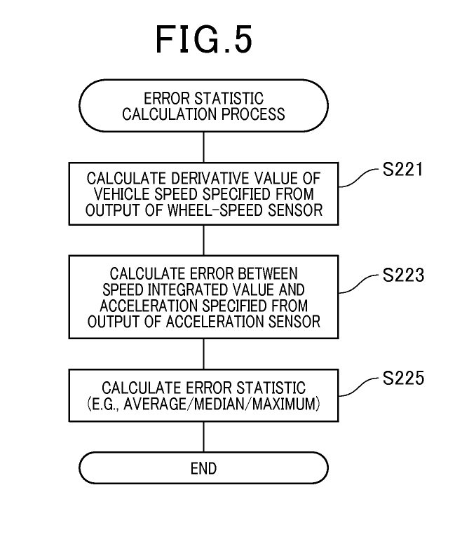

After transfer to step S220, the control unit 17 carries out the error statistic calculation process shown in FIG. 5. In the error statistic calculation process, the control unit 17 calculates, first, a derivative value of a vehicle speed specified from the output of the wheel-speed sensor 30 to thereby calculate an acceleration of the vehicle corresponding to rotation acceleration of the wheel (step S221). For example, the derivative value can be calculated by obtaining a deviation of the vehicle speed at a time point of executing step S221 in the previous cycle from the vehicle speed at a time point of executing step S221 in the present cycle, and dividing the deviation by the execution cycle between the previous and present steps S221.

After finishing the processing at step S221, the control unit 17 specifies the acceleration of the vehicle from the output of the acceleration sensor 40, and calculates an error (absolute value) between the acceleration and the speed derivative value calculated at step S221 (step S223). Such errors that are obtained every time step S223 is performed from when the error statistic has been reset to the value zero last at step S250 are used as a sample group, thereby calculating a statistic of the errors in the sample group (step S225). Specifically, at step S225, an average value of the errors calculated up to then is calculated, as an example. Alternatively, a median of the errors in the sample group may be calculated as an error statistic, or a maximum value of the errors in the error sample may be calculated as an error statistic. At step S205, the error statistic may be reset to the value zero, while deleting the sample group used up to then.

After that, the control unit 17 transfers to step S230 and determines, similar to the processing at step S130, whether or not the vehicle speed specified from the output of the wheel-speed sensor 30 has exceeded a reference speed.

The, if the vehicle speed specified from the output of the wheel-speed sensor 30 is determined not to have exceeded the reference speed (No at step S230), the control unit 17 transfers to step S200 and repeatedly performs the processings from steps S200 to S230 until the vehicle speed exceeds the reference speed. On the other hand, if the vehicle speed is determined to have exceeded the reference speed (Yes at step S230), control transfers to step S250. At step S250, it is determined whether or not the latest error statistic calculated at step S220 is less than a threshold determined in advance at a design stage.

Then, if the error statistic is determined to be less than the threshold (Yes at step S250), the determination flag F is set to the value 1, while setting the learning enable flag G to the value 1 (step S253), followed by transferring to step S260. On the other hand, if the error statistic is determined to be not less than the threshold (No at step S250), the determination flag F is set to the value 1, while retaining the state where the learning enable flag G is reset to the value 0 (step S257), followed by transferring to step S260. The threshold used at step S250 can be determined by a designer along similar lines to that of the threshold used at step S150 of the first embodiment.

After that, the control unit 17 determines whether or not the learning enable flag G is set to the value 1 (step S260). If the learning enable flag G is determined to be set to the value 1 (Yes at step S260), the focus-of-expansion learning process PR1 is started (step S270), followed by transferring to step S280. If a negative determination is made (No at step S260), the learning control process is temporarily halted without performing the focus-of-expansion learning process PR1.

After transfer to step S280, the control unit 17 determines, similar to the processing at step S180, whether or not the termination conditions of the focus-of-expansion learning process PR2 have been met. If the termination conditions are determined not to have been met (No at step S280), a determination at step S280 is repeatedly made until the termination conditions are met. If the termination conditions are determined to have been met (Yes at step S280), the focus-of-expansion learning process PR1 is terminated (step S290), followed by temporarily halting the learning control process PR2.

Further, in a learning control process which is performed again after performing the processings of step S250 onward and temporarily halting the learning control process, the control unit 17 makes use, similar to the first embodiment, of the determination results of step S250 of the past to control on/off of the learning performance, until the vehicle speed specified from the output of the wheel-speed sensor 30 temporarily drops down to zero.

In other words, in the learning control process performed again until the vehicle speed temporarily drops down to zero, an affirmative determination is made at step S210 and then control transfers to step S235, and then, similar to the processing at step S230, it is determined whether or not the vehicle speed specified from the output of the wheel-speed sensor 30 has exceeded the reference speed. Then, if the vehicle speed is determined not to have exceeded the reference speed (No at step S235), control transfers to step S200. If the vehicle speed is determined to have exceeded the reference speed (Yes at step S235), control transfers to step S260. Then, in the processings of step S260 onward (steps S260 to S290), the focus-of-expansion learning process PR1 is started (step S270), as far as an affirmative determination has been made at step S250 of the learning control process in the past and the learning enable flag G is set to the value 1 (Yes at step S260).

According to the second embodiment described above, on/off control of the learning performance is performed on the basis of an error between an acceleration of the vehicle calculated from the deviation in a speed of the vehicle, which is specified from the output of the wheel-speed sensor 30, and an acceleration of the vehicle specified from the output of the acceleration sensor 40. Under such control as well, advantageous effects similar to those of the first embodiment can be obtained.

### Third Embodiment

Subsequently, a third embodiment is described.

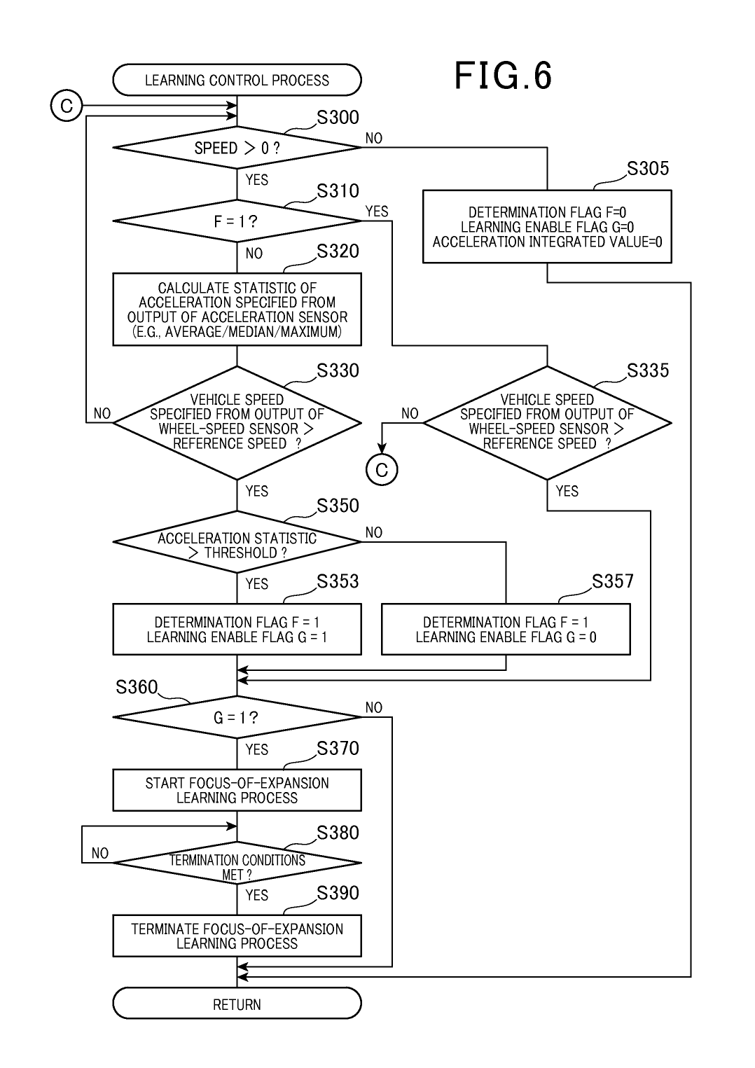

The vehicle control system 1 of the third embodiment is different to some extent from the first embodiment in the learning control process PR2 performed by the control unit 17. Accordingly, the learning control process PR2 of the third embodiment is selectively described below. In the present embodiment, the control unit 17 starts the learning control process PR2 shown in FIG. 6 when the ignition switch is turned on, and repeatedly performs the process at a predetermined cycle until the ignition switch is turned off.

Upon start of the learning control process PR2, the control unit 17 determines whether or not the vehicle speed specified from the output of the wheel-speed sensor 30 is higher than zero (step S300). If the vehicle speed is determined to be not more than zero, control transfers to step S305. If the vehicle speed is determined to be higher than zero, control transfers to step S310.

After transfer to step S305, the control unit 17 resets, similar to the processing at step S105, the determination flag F and the learning enable flag G to the value zero, while resetting an acceleration statistic to a value zero, followed by temporarily halting the learning control process PR2. The acceleration statistic is calculated at step S320 discussed later.

On the other hand, after transfer to step S310, the control unit 17 determines whether or not the determination flag F is set to the value 1. If the determination flag F is determined to be set to the value 1 (Yes at step S310), control transfers to step S335. If the determination flag F is determined not to be set to the value 1 (No at step S310), control transfers to step S320.

After transfer to step S320, the control unit 17 specifies an acceleration of the vehicle of the moment from the output of the acceleration sensor 40. Then, the control unit 17 calculates a statistic of the accelerations observed and measured by the acceleration sensor 40 from when the acceleration statistic has been reset to the value zero last at step S305. Specifically, as an example, at step S320, the control unit 17 calculates, as an acceleration statistic, an average value of the accelerations from a time point when the acceleration statistic has been reset to the value zero last at step S305. Alternatively, a median of the accelerations may be calculated, or a maximum value of the accelerations may be calculated, as an acceleration statistic.

After finishing the processing at step S320, the control unit 17 transfers to step S330 and compares, similar to the processing at step S130, the vehicle speed specified from the output of the wheel-speed sensor 30 with a reference speed. If the vehicle speed is determined not to have exceeded the reference value (No at step S330), control transfers to step S300. The control unit 17 repeatedly performs the processings of steps S300 to S330 until the vehicle speed exceeds the reference speed.

Then, if it is determined that the vehicle speed specified from the output of the wheel-speed sensor 30 has exceeded the reference speed (Yes at step S330), control transfers to step S350. At step S350, it is determined whether or not the latest acceleration statistic calculated at step S320 exceeds a threshold determined in advance at a design stage.

Then, if the acceleration statistic is determined to have exceeded the threshold (Yes at step S350), the determination flag F is set to the value 1, while the learning enable flag G is set to the value 1 (step S353), followed by transferring to step S360. In contrast, if it is determined that the acceleration statistic is not more than the threshold (No at step S350), the determination flag F is set to the value 1, while retaining a state where the learning enable flag G is reset to the value 0 (step S357), followed by transferring to step S360. The threshold may be determined along a line similar to that of the threshold used at step 150 of the first embodiment.

After that, the control unit 17 determines whether or not the learning enable flag G is set to the value 1 (step S360). If the learning enable flag G is determined to be set to the value 1 (Yes at step S360), the focus-of-expansion learning process PR1 is started (step S370), followed by transferring to step S380. If a negative determination is made (No at step S360), the learning control process is temporarily halted without starting the focus-of-expansion learning process PR1.

After transfer to step S380, the control unit 17 determines, similar to the processing at step S180, whether or not the termination conditions of the focus-of-expansion learning process PR1 have been met. If the termination conditions are determined not to have been met (No at step S380), a determination at step S380 is repeatedly made until the termination conditions are met. If the termination conditions are determined to have been met (Yes at step S380), the focus-of-expansion learning process PR1 is terminated (step S390), followed by temporarily halting the learning control process PR2.

Further, in a learning control process which is performed again after performing the processings of step S350 onward and temporarily halting the learning control process, the control unit 17 makes use, similar to the first embodiment, of the determination results of step S350 of the past to control on/off of the learning performance, until the vehicle speed specified from the output of the wheel-speed sensor 30 temporarily drops down to zero.

In other words, in the learning control process performed until the vehicle speed temporarily drops down to zero, an affirmative determination is made at step S310, followed by transferring to step S335, and then it is determined, similar to the processing at step S330, whether or not the vehicle speed specified from the output of the wheel-speed sensor 30 has exceeded the reference speed. Then, if the vehicle speed is determined not to have exceeded the reference speed (No at step S335), control transfers to step S300. If the vehicle speed is determined to have exceeded the reference speed (Yes at step S335), control transfers to step S360. In the processings of step S360 onward (steps S360 to S390), the focus-of-expansion learning process PR1 is started, similar to the first embodiment, as far as an affirmative determination has been made at step S350 of the learning control process in the past and thus the learning enable flag G is set to the value 1.

The third embodiment has so far been described. According to the present embodiment, the learning performance is switched from an off-state to an on-state on condition that the vehicle speed specified from the output of the wheel-speed sensor 30 has exceeded a reference speed (Yes at step S330) and the vehicle acceleration specified from the output of the acceleration sensor 40 (acceleration statistic) has exceeded a threshold (Yes at step S350). Under such a control process as well, the learning performance for a focus-of-expansion position can be properly performed.

### Fourth Embodiment

Subsequently, a fourth embodiment is described.

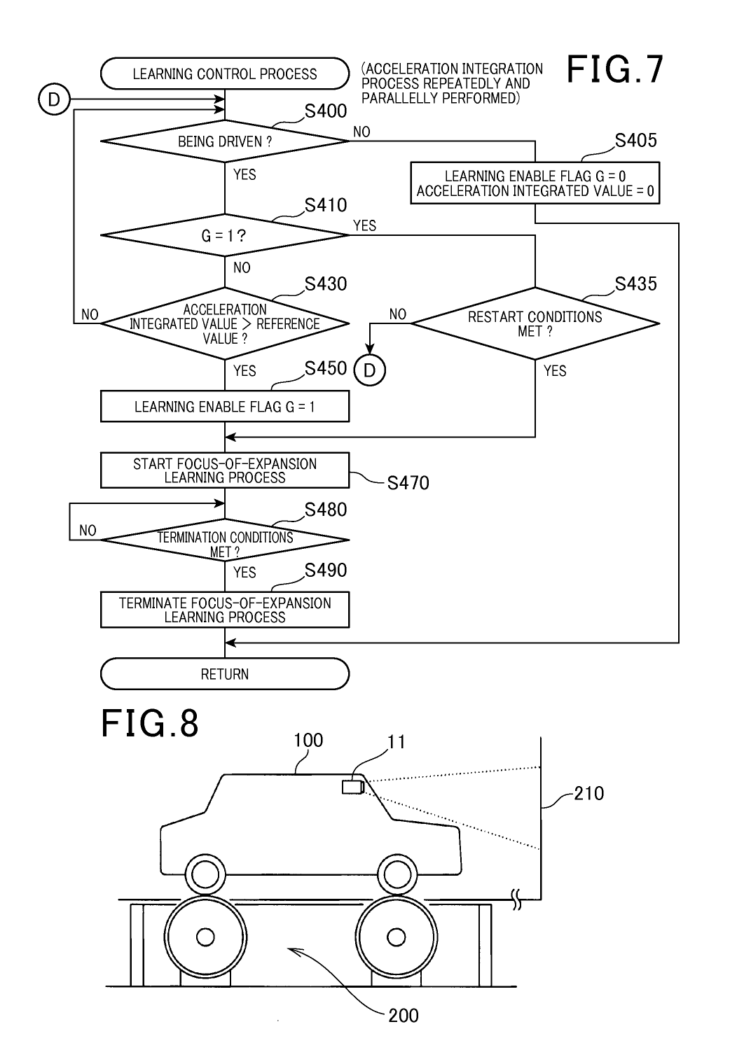

The vehicle control system 1 of the fourth embodiment is different to some extent from the first embodiment in the learning control process PR2 performed by the control unit 17. Accordingly, the learning control process PR2 in the fourth embodiment is selectively described below. The control unit 17 of the present embodiment starts the learning control process PR2 shown in FIG. 7 when the ignition switch is turned on, and repeatedly performs the process at a predetermined cycle until the ignition switch is turned off.

Upon start of the learning control process PR2, the control unit 17 determines, first, whether or not the vehicle is in a state of being driven (step S400). For example, similar to the first embodiment, whether or not the vehicle is in a state of being driven is determined depending on whether or not the vehicle speed specified from the output of the wheel-speed sensor 30 is higher than zero. Alternatively, whether or not the vehicle is in a state of being driven may be determined depending on whether or not the select lever is set in a drive range.

Then, if the vehicle is determined not to be in a state of being driven (No at step S400), control transfers to step S405. If the vehicle is determined to be in a state of being driven (Yes at step S400), control transfers to step S410.

After transfer to step S405, the control unit 17 resets the learning enable flag G to a value zero, while resetting an acceleration integrated value to a value zero, followed by temporarily halting the learning control process PR2. In the present embodiment, the acceleration integrated value is calculated in an acceleration integration process which is a process belonging to the learning control process PR2 and is performed in parallel with the learning control process PR2.

The acceleration integration process is similar to step S120 of the first embodiment. In the present embodiment, separate from the processing loop of the learning control process PR2, the control unit 17 constantly and repeatedly performs the acceleration integration process at a predetermined execution cycle from when the ignition switch is turned on until when the ignition switch is turned off, thereby calculating an integrated value of acceleration that has been observed and measured by the acceleration sensor 40 since the vehicle has been started to be driven. Thus, the actual speed of the vehicle is constantly estimated. At step S405, a processing of resetting the acceleration integrated value to zero is performed.

On the other hand, after transfer to step S410, the control unit 17 determines whether or not the learning enable flag G is set to the value 1. If the learning enable flag G is determined to be set to the value 1 (Yes at step S410), control transfers to step S435. If the learning enable flag G is determined not to be set to the value 1 (No at step S410), control transfers to step S430.

Further, at step S430, it is determined whether or not the latest acceleration integrated value calculated in the acceleration integration process has exceeded a reference value that is determined in advance at a design stage. The “reference value” used herein may have the same value as the reference speed used at step S130.

Then, if the acceleration integrated value is determined to be not more than the reference value (No at step S430), the control unit 17 transfers to step S400 to repeatedly perform the processings of steps S400 to S430 until the acceleration integrated value exceeds the reference value (Yes at step S430). If the acceleration integrated value is determined to have exceeded the reference value (Yes at step S430), control transfers to step S450. At step S450, the control unit 17 sets the learning enable flag G to the value 1, followed by starting the focus-of-expansion learning process PR1 (step S470). Then, control transfers to step S480.

After transfer to step S480, the control unit 17 determines, similar to the processing at step S180, whether or not the termination conditions of the focus-of-expansion learning process PR1 have been met. In this case, whether or not the termination conditions have been met may be determined without using the wheel-speed sensor 30. For example, whether or not the termination conditions have been met may be determined using a process similar to that of the first embodiment, on the basis of a vehicle speed specified from the latest acceleration integrated value which is calculated in the acceleration integration process, in place of a vehicle speed specified by the wheel-speed sensor 30. Alternatively, whether or not the termination conditions have been met may be determined by determining, on the basis of a gear position, whether or not the vehicle is in a low-speed run.

Then, if the termination conditions are determined not to have been met (No at step S480), a determination at step S480 is repeatedly made until the termination conditions are met. If the termination conditions are determined to have been met (Yes at step S480), the focus-of-expansion learning process PR1 is terminated (step S490), followed by temporarily halting the learning control process PR2.

Further, in the learning control process performed again after performing the processings of step S450 onward, followed by temporarily halting the learning control process, the learning enable flag G is retained to be the value 1 until the vehicle is determined to be in a state of being driven (No at step S400). Thus, an affirmative determination is made at step S410 and control transfers to step S435. Then, at step S435, it is determined, as follows, whether or not restart conditions for the learning performance have been met.

At step S435, for example, similar to the processing at step S430, if the acceleration integrated value has exceeded the reference value, the restart conditions are determined to have been met. If the acceleration integrated value is not more than the reference value, the restart conditions are determined not to have been met.

As another example, a difference V1−V2 may be calculated, where V1 is the latest acceleration integrated value calculated in the acceleration integration process, and V2 is an acceleration integrated value at a time point when the focus-of-expansion position learning process has been terminated last (time point of performing step S490). If the difference V1−V2 is not less than a threshold determined in advance at a design stage, the restart conditions may be determined to have been met. If the difference V1−V2 is determined to be less than the threshold, the restart conditions may be determined not to have been met. The threshold may be set to a value that can draw out a determination that the restart conditions are met in a situation in which the vehicle speed exceeds the reference speed.

As still another example, similar to the processings at steps S135, S235 and S335, the restart conditions may be determined to have been met if the vehicle speed specified from the output of the wheel-speed sensor 30 has exceeded the reference speed. If the vehicle speed has not exceeded the reference speed, the restart conditions may be determined not to have been met.

The control unit 17 determines, in this way, whether or not the restart conditions have been met. If the restart conditions are determined not to have been met (No at step S435), control transfers to step S400. On the other hand, if the restart conditions are determined to have been met (Yes at step S435), control transfers to step S470, followed by starting the focus-of-expansion learning process PR1.

The forth embodiment has so far been described. According to the present embodiment, the learning performance is switched from an off-state to an on-state on condition that the vehicle speed calculated by integrating an acceleration of the vehicle, which is specified from the output of the acceleration sensor 40, has exceeded the reference speed. According to such a control process as well, the learning performance for a focus-of-expansion position can be properly performed, while suppressing error learning.

Other Variations

The present invention should not be construed as being limited to the modes described in the above embodiments, but may have various modes. For example, similar to the determination made at step S400, the determinations made at steps S100, S200 and S300 may each be replaced by a determination as to whether or not the vehicle is being driven. Further, as a matter of course, the learning performance may be on/off-controlled using a method other than those of the above embodiments, as long as the output of an inertia sensor is used.

For example, as a modification of the first embodiment, similar to the fourth embodiment, the acceleration integration process (step S120) may be performed in parallel with the learning control process PR2 to thereby constantly estimate the actual speed of the vehicle from when the vehicle has been started to be driven, on the basis of the output of the acceleration sensor 40. According to this example, the on/off control for the learning performance may be performed without using a determination result of the past of step S150. In other words, in an embodiment, the determination step of step S110 may be deleted to perform the processings of steps S140 and S150 to S157 over again in the learning control process PR2 performed again, on the basis of the acceleration integrated value of the moment.

In the embodiments described above, the image analysis apparatus 10 corresponds to an example of an electronic machine mounted to the vehicle. Further, the focus-of-expansion learning process PR1 performed by the control unit 17 corresponds to an example of a process realized by the learning means. The learning control process PR2 performed by the control unit 17 corresponds to an example of a process realized by the controlling means.

### REFERENCE SIGNS LIST

1 . . . Vehicle control system,
10 . . . Image analysis apparatus,
11 . . . Camera,
15 . . . Communication interface,
17 . . . Control unit,
17A . . . CPU,
17B . . . ROM,
17C . . . RAM,
20 . . . Vehicle control apparatus,
30 . . . Wheel-speed sensor,
40 . . . Acceleration sensor,
100 . . . Vehicle,
200 . . . Chassis dynamometer,
210 . . . Wall

What is claimed is:

1. An image analysis apparatus mounted to a vehicle, comprising:
a camera that picks up an image of a field of view in a forward direction of the vehicle and generates image data that show the picked-up image;
a learning means for analyzing the image data generated by the camera and learning a position of a focus of expansion; and
controlling means for controlling switching on/off of a learning performance for the position of a focus of expansion performed by the learning means, on the basis of an output of an acceleration sensor provided to the vehicle,
wherein
the controlling means comprises:
running determining means for determining whether or not the vehicle is in a state of running on a road, on the basis of an output of the acceleration sensor;
switching means for switching the learning performance from an off-state to an on-state when the running determining means determines the running state; and
error determining means for determining whether or not an error is less than a reference value, the error being between an acceleration of the vehicle calculated from a deviation in a speed of the vehicle specified from an output of a wheel-speed sensor provided to the vehicle, and an acceleration of the vehicle specified from an output of the acceleration sensor, or between a speed of the vehicle specified from an output of the wheel-speed sensor and a speed of the vehicle calculated by integrating an acceleration of the vehicle specified from an output of the acceleration sensor, and
the switching means is configured to switch the learning performance from an off-state to an on-state when the error is determined to be less than the reference value by the error determining means.

2. (canceled)

3. (canceled)

4. (canceled)

5. The image analysis apparatus according to claim 1, wherein:
the controlling means comprises a first speed determining means for determining whether or not a speed of the vehicle specified from an output of the wheel-speed sensor has exceeded a reference speed; and
the switching means is configured to switch the learning performance from an off-state to an on-state, on condition that a speed of the vehicle is determined to have exceeded the reference speed by the first speed determining means, and the error is determined to be less than the reference value by the error determining means.

6. The image analysis apparatus according to claim 5, wherein:
the controlling means comprises an acceleration determining means for determining whether or not an acceleration of the vehicle specified from an output of the acceleration sensor has exceeded a reference acceleration; and
the switching means is configured to switch the learning performance from an off-state to an on-state, on condition that a speed of the vehicle is determined to have exceeded the reference speed by the first speed determining means, and an acceleration of the vehicle is determined to have exceeded the reference acceleration by the acceleration determining means.

7. The image analysis apparatus according to claim 1, wherein:
the controlling means comprises an inhibition speed determining means for setting a learning performance for a focus-of-expansion position performed by the learning means to an on-state and then determining whether or not a speed of the vehicle has become not more than an inhibition speed for the learning performance predetermined in advance on the basis of the reference speed or a speed lower than the reference speed; and
the switching means is configured to switch the learning performance performed by the learning means to an off-state when a speed of the vehicle is determined to be not more than the inhibition speed.

8. (canceled)

9. The image analysis apparatus according to claim 1, wherein the learning means is configured to learn the focus-of-expansion position on the basis of an estimation result of road division lines shown in the image data.
